(19) United States
(12) Patent Application Publication
(10) Pub. No.: US 2026/0210829 A1
(43) Pub. Date: Jul. 23, 2026

(54) AUTOMATED ERYTHROCYTE SEDIMENTATION RATE ANALYZER WITH PRE-SCAN MODULE AND MIXING DEVICE FOR ENHANCED THROUGHPUT AND RELATED METHODS

(71) Applicant: ALCOR Scientific LLC, Smithfield, RI (US)

(72) Inventors: Francesco FRAPPA, Udine (IT); J. Joseph LANGELLA, Warwick, RI (US); James POST, Sarasota, FL (US); Maximo SIERRA, Johnston, RI (US); Boris GALPERIN, Ashland, MA (US); Adam MURATORI, Greenville, RI (US)

(21) Appl. No.: 19/570,114

(22) Filed: Mar. 17, 2026

Related U.S. Application Data
(63) Continuation-in-part of application No. 17/906,189, filed on Jan. 26, 2022.
(63) Continuation-in-part of application No. 17/933,986, filed on Sep. 21, 2022.
(60) Provisional application No. 63/142,174, filed on Jan. 27, 2021.
(60) Provisional application No. 63/246,923, filed on Sep. 22, 2021.

(51) Int. Cl. G01N 15/05; G01N 35/00; G01N 35/04; G01N 35/10

(52) U.S. Cl. CPC G01N 15/05; G01N 35/00732; G01N 35/0092; G01N 35/0099; G01N 35/1009; G01N 35/1079; G01N 35/1095; G01N 2035/00524; G01N 2035/00752; G01N 2035/00831; G01N 2035/0094; G01N 2035/0401

(57) ABSTRACT

An erythrocyte sedimentation rate (ESR) analyzer designed to efficiently process blood samples. The analyzer includes a scanner module that identifies blood samples requiring ESR analysis by scanning barcodes on collection tubes. It selectively processes only those samples, bypassing others. The analyzer further includes a robotic arm and mixer device configured to mix selected blood samples and to simultaneously permit automated loading and unloading of collection tubes at a first position and automated piercing of collection tubes at a second position. A reading cell container receives the sample portion, where a light emitter and optical receiver work together to determine the ESR value by detecting scattered light. The method involves using the analyzer to scan, select, mix, and measure blood samples, optimizing the process by reducing handling and processing time for samples not requiring analysis.

### CROSS REFERENCE TO RELATED APPLICATIONS

This application is a continuation-in-part of U.S. patent application Ser. No. 17/906,189, filed Sep. 12, 2022, now published as U.S. Pat. Appl. Publication No. 2023/0116470A1, which is a national phase filing under 35 U.S.C. § 371 of International Application No. PCT/US2022/013931 filed Jan. 26, 2022, which claims benefit from U.S. Provisional Patent Application Ser. No. 63/142,174, filed Jan. 27, 2021, and is also a continuation-in-part of U.S. patent application Ser. No. 17/933,986, filed Sep. 21, 2022, now published as U.S. Pat. Appl. Publication No. 2023/009 1139A1, which claims benefit from U.S. Provisional Patent Application Ser. No. 63/246,923, filed Sep. 22, 2021, the contents of which are incorporated herein by reference in their entireties.

### FIELD OF THE INVENTION

The present disclosure relates to an automated erythrocyte sedimentation rate (ESR) analyzer and a method for its use, and more particularly, to an ESR analyzer designed to enhance throughput and efficiency in diagnostic laboratories.

### BACKGROUND OF THE INVENTION

Medical analyzers are used to measure various functions of a patient. For example, an erythrocyte sedimentation rate (ESR) analyzer measures an ESR or sed rate, which is a clinical lab test that measures the rate at which red blood cells in whole blood descend into a standardized tube, reported as mm per hour. This test is used to measure inflammation because red blood cells of patients with inflammation settle quicker than in normal patients. Thus, a high ESR can be indicative of elevated inflammation, though other conditions such as anemia, renal failure, and obesity can increase ESR rate as well.

The field of automated laboratory analyzers are integral to the operation of modern laboratories, where efficiency and precision are paramount. Automated analyzers are designed to handle a variety of tests, including hematology, chemistry, and immunoassays, each requiring specific handling and processing techniques. The ability to process large volumes of samples with minimal human intervention not only reduces the potential for error but also significantly enhances laboratory productivity. As the demand for faster and more reliable diagnostic results continues to grow, innovations in automated analyzer technology remain an important focus for the industry.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features an analyzer including an analytical unit, the analytical unit including at least a mixing wheel, a piercing system, a reading cell and a hydraulic system, a rack holding system holding homogeneous racks, each of the homogeneous racks including sample tubes, a robotic arm to pick up sample tubes from any of the homogeneous racks and load the sample tubes into the mixing wheel, and a system handler processor, the analytical unit, the rack holding system and the robotic arm communicatively linked by the system handler processor.

In another aspect, the invention features a method including providing an analyzer, the analyzer including an analytical unit, the analytical unit including at least a mixing wheel, a piercing system, a reading cell and a hydraulic system, a rack holding system holding homogeneous racks, each of the homogeneous racks including sample tubes, a robotic arm to pick up sample tubes from any of the homogeneous racks and load the sample tubes into the mixing wheel, and a system handler processor, the analytical unit, the rack holding system and the robotic arm communicatively linked by the system handler processor, selecting a rack of sample tubes; picking up each one of the sample tubes in the selected rack with a robotic arm and placing the picked sample tube into a mixing wheel, performing an analysis on the picked sample tube, and returning the picked sample tube to the selected rack.

In an aspect, the present invention provides an ESR analyzer that can include a scanner module configured to receive racks of blood samples. Each blood sample is contained in a corresponding collection tube. The scanner module is further configured to scan a barcode on each blood sample collection tube to identify blood samples requiring ESR analysis. Blood samples not requiring ESR analysis are excluded from further processing. If no blood samples in a rack require ESR analysis, the entire rack is automatically bypassed. If only some blood samples in a rack require ESR analysis, only those selected blood sample collection tubes proceed to further processing. The ESR analyzer can include a mixer device, such as a rotating mixing wheel, configured to mix the blood samples within their respective collection tubes. A robotic arm can be included to load and unload blood samples requiring ESR analysis into the mixer device. The mixer device can be configured to permit simultaneous automated loading and unloading of blood sample collection tubes at a first position on the mixing device, via the robotic arm, and automated piercing of the blood sample collection tubes at a second position on the mixer device. Loading and unloading operations and piercing operations can thus occur concurrently at different positions on the mixer device. The ESR analyzer can include a needle configured for insertion into a collection tube to withdraw a portion of the mixed blood sample from the collection tube. The needle can be connected to a hydraulic circuit for transporting the withdrawn blood sample using a pump. The withdrawn blood sample portion can be transported to a reading cell container connected to the hydraulic circuit. The ESR analyzer can include a light emitter source positioned to pass light through the blood sample portion and an optical receiver to detect scattered light, thereby obtaining an ESR-related signal to determine an ESR value.

In another aspect, the present invention provides a method for determining ESR of blood samples. The method generally includes providing the ESR analyzer as described herein, receiving a plurality of blood samples, each in a corresponding collection tube, and scanning a barcode on each tube to identify those requiring ESR analysis. The method can include selecting the identified blood samples for further processing while excluding others. The method can include mixing the selected blood samples using a mixer device, with automated loading and unloading via a robotic arm, and automated piercing of the tubes. The method can include inserting a needle within a collection tube to withdraw a blood sample portion, transporting it to a reading cell container, emitting light through the blood sample portion, and detecting scattered light to determine an ESR value.

In another aspect, the present invention provides a method for processing blood samples for ESR determination using an automated ESR analyzer having a reading cell, an optical detection assembly, a hydraulic transport circuit, and a robotic arm. The method generally includes receiving blood sample collection tubes in a rack into a sample handling region of the analyzer. The method generally includes scanning a barcode on each tube to determine the need for ESR analysis, selecting tubes requiring analysis, and excluding others. The method generally includes loading selected tubes onto a rotatable mixing wheel, rotating the wheel to move each tube through operational positions for loading and unloading, mixing, and piercing, withdrawing a blood sample portion, transporting it to a reading cell, and optically measuring the sample to obtain an ESR-related signal and determine an ESR value. The method is designed to reduce handling and processing of samples not requiring ESR analysis, thereby improving efficiency and accuracy.

One or more of the following features can be included. Scanning the barcode can include querying a Laboratory Integration System (LIS) using the barcode to obtain at least one of a test order, patient identifier, sample identifier, tube type, priority status, and expiration date. The barcode-derived information can be used to prioritize selected blood sample collection tubes on the mixing wheel. The barcode reader can prevent loading improperly identified or expired blood sample collection tubes. The mixing wheel can be configured to permit simultaneous automated loading and unloading of collection tubes at a first position on the mixing wheel and automated piercing of collection tubes at a second position on the mixing wheel. The mixing wheel can operate in indexed rotational steps corresponding to discrete operational positions.

Mixing can be performed for a predetermined duration prior to piercing. Piercing can occur at a fixed angular position of the mixing wheel relative to the needle. The mixing wheel can include multiple tube holders configured to maintain the blood sample collection tubes in a substantially vertical orientation during insertion of the blood sample collection tubes into the mixing wheel. Loading/unloading and piercing can be coordinated such that piercing occurs immediately after mixing without intermediate dwell time. The blood sample can remain in a mixed state during withdrawal to reduce reaggregation phenomena that can induce measurement errors. Mixing and piercing can be performed without removing the blood sample collection tube from the mixing wheel.

The ESR value can be determined using the red blood cell rate of aggregation. The red blood cell aggregation rate can be derived from a time-dependent change in the optically detected signal. The optical measurement step can be performed while the blood sample portion is stationary inside the reading cell. Excluding blood sample collection tubes not requiring ESR analysis can reduce mechanical stress on piercing components. Selective processing can reduce overall sample-to-sample cycle time. The barcode scanning, robotic arm, mixing wheel rotation, piercing, withdrawal, and optical measurement steps can be coordinated by a processor or other electronic control system.

In another aspect, coordinated control of barcode scanning, robotic handling, mixing wheel rotation, piercing, withdrawal, fluid transport, and optical detection & measurement all coordinated via a electronic control system reduces handling of unnecessary samples, decreases cycle time, and improves analyzer throughput and reliability.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a block diagram of an automated ESR analyzer according to one embodiment of the present invention.

FIG. 2 is an illustration of an exemplary system.

FIG. 3 is an illustration of an exemplary fully loaded system.

FIG. 4 is an illustration of an exemplary analytical unit.

FIG. 5 is an illustration of an exemplary rack holding system.

FIG. 6 is an illustration of an exemplary robotic arm.

FIG. 7 is another illustration of an exemplary robotic arm.

FIG. 8 is an illustration of an exemplary loading rack.

FIG. 9 is an illustration of an exemplary piercing system reading cell.

FIG. 10 is an illustration of an exemplary mixing wheel.

FIG. 11 is an illustration of an exemplary robotic arm, collection tube, and mixing wheel interaction.

FIG. 12 is a block diagram of an automated ESR analyzer according to another embodiment of present invention.

FIG. 13 illustrates an ESR analyzer according to an embodiment of the present invention.

FIG. 14 illustrates an ESR analyzer integrated with other diagnostic equipment in a laboratory environment.

FIG. 15 is a block diagram illustrating internal components and external interfaces of an ESR analyzer configured in accordance with an embodiment of the present invention.

FIG. 16 illustrates an ESR analyzer and external rack holding mechanism in accordance with an embodiment of the present invention.

FIG. 17A and FIG. 17B illustrate an ESR analyzer and rack holding mechanisms in accordance with another embodiment of the present invention.

FIG. 18A and FIG. 18B illustrate the internal operation of an ESR analyzer configured in accordance with an embodiment of the present invention.

FIG. 19A and FIG. 19B illustrate a scanner module scanning barcodes on blood sample collection tubes in accordance with an embodiment of the present invention.

FIG. 20A and FIG. 20B illustrate a bypass path for blood sample collection tubes not requiring ESR analysis in accordance with an embodiment of the present invention.

FIG. 21 illustrates a mixing wheel and piercing mechanism configured in accordance with an embodiment of the present invention.

FIG. 22A and FIG. 22B illustrate a robotic arm manipulating racks of blood sample collection tubes in accordance with an embodiment of the present invention.

FIG. 23 is a flowchart illustrating a method for determining an ESR of blood samples in accordance with an embodiment of the present invention.

FIG. 24 is a flowchart illustrating a method for processing blood samples for ESR determination in accordance with an embodiment of the present invention.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The present invention will now be described with reference to ESR testing. However, techniques described herein are not limited to ESR testing and may be adapted to a variety of test systems.

Erythrocyte sedimentation rate (ESR) testing is typically performed using analyzers. These analyzers speed run time, while enhancing safety and accuracy. One standard technique for ESR testing is called the Westergren Method in which whole blood is mixed with sodium citrate or ethylenediaminetetraacetic acid (EDTA) as an anticoagulant and then added to a standardized calibrated tube, which is allowed to sit for one hour. Sedimentation rate is measured by recording the number of millimeters between the top of the sedimented red blood cells and the zero mark of the tube. Many analyzers operate using the Westergren Method, though instruments employing alternative methods have begun to emerge. Features important in an ESR analyzer include, for example, its capacity, run time, throughput, dimensions, sample tracking features and so forth. Commercially available ESR analyzers include, for example, the iSED® ESR Analyzer and the miniiSED® ESR Analyzer, both from Alcor Scientific Inc.

It should be noted that the system and method described herein does not measure according to the Westergren method. Instead, system and method described herein measures aggregation optically and then converts the obtained data to an equivalent Westergren result expressed in mm/h.

There is a portion of the ESR analyzer market that uses racks as media to transport sample tubes. The system of the present invention is capable of loading a number of tubes contained into racks already in use on analyzers rather than loading tubes one by one into a mixing wheel.

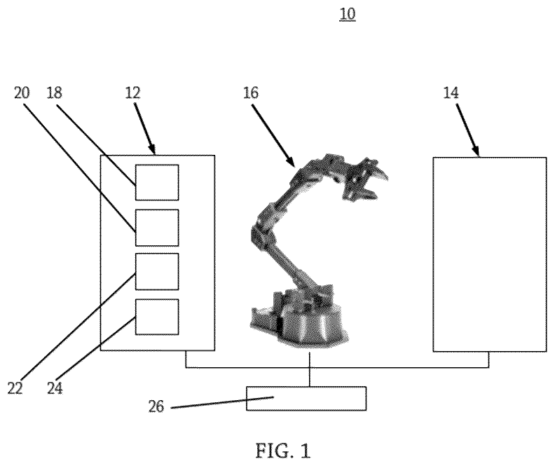

Referring to FIG. 1, an exemplary ESR analyzer 10 can include an analytical unit 12, a rack holding system 14 and a robotic arm 16. The rack holding system 14 can hold any number of homogeneous racks. For example, the rack holding system 14 may contain one rack of ten samples tubes, each of which may be pierced. The robotic arm 16 picks up a sample tube from any rack position in the rack and loads it into a mixing wheel 18 of the analytical unit 12. After insertion, each rack is locked in position until all its tubes have been processed. After completion, the rack is released for manual extraction. A rack is considered completely processed when all its contained tubes are evaluated for measurement and re-positioned on its original pickup location.

Potentially, not all the tubes inside the rack require ESR analysis. Therefore, the ESR Analyzer 10 extracts a tube from its rack location, identifies the extracted tube using, for example, barcode label detection, executes a request to a Laboratory Integration System (LIS) and, in case ESR analysis is not required, immediately repositions the tube on its original position. If ESR analysis is required, the sample tube is placed on the mixing wheel, where the measurement process starts. This step is executed for all samples inserted into the ESR Analyzer 10 with coordination with the mixing wheel. After a tube is measured successfully by the analytical unit 12, which includes the mixing wheel 18, a piercing system 20, a reading cell 22 and a hydraulic system 24, the mixing wheel 18 positions the tube ready for extraction on a loading/downloading position, to enable the robotic arm 16 to extract it and position it back on its position of origin inside the rack in the rack holding system 14.

The ESR analyzer 10 also includes system handler processor 26. The analytical unit 12, the rack holding system 14 and the robotic arm 16 are all in communication to each other via the system handler processor 26.

The rack holding system 14 is interchangeable based on rack type, such Sysmex®, Beckman Coulter®, and so forth. The rack holding system 14 may include one or more of the following features. The rack holding system 14 may be able to receive more than one rack, lock the rack in place via, for example, a solenoid latch, notify a user via visual indication of a rack status, notify the system which rack is meant to receive to adjust pick and place coordinates, and able to release the rack when completed.

The robotic arm 16 is able to reach every rack location, grip each sample tube inside the rack and extract sample tubes from the rack. The robotic arm 16 is able to detect a sample tube ID via, for example, barcode reader, able to position the extracted tube into the mixing wheel and able to re-position the measured tube from the mixing wheel to the original rack position.

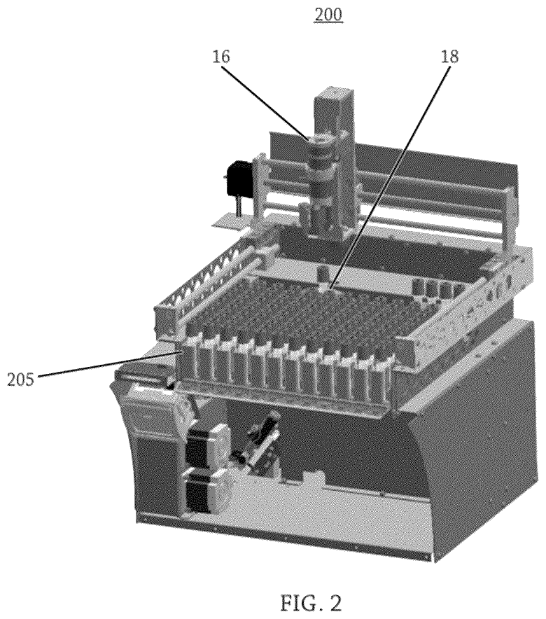

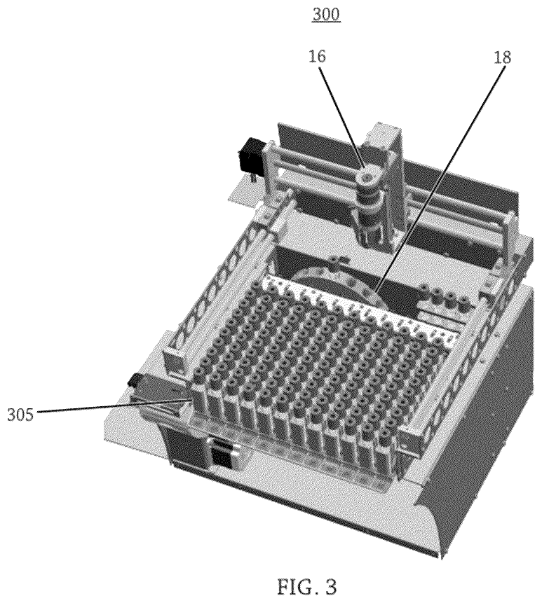

In FIGS. 2 and 3, exemplary systems 200, 300, respectively, are illustrated. In each case, racks 205, 305, respectively, are fully loaded.

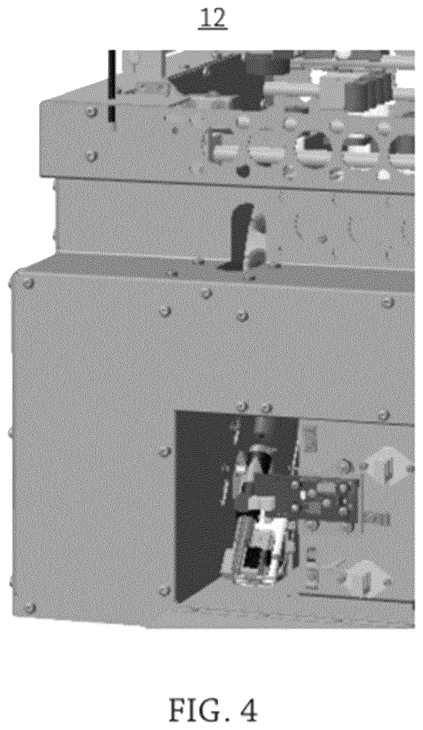

In FIG. 4, the analytical unit 12 is illustrated. In one example, the analytical unit measures sedimentation rate via evaluation of red blood cell aggregation by digitizing and recording the optical variation inside the reading cell over time and mathematically process and convert these optical values to a value comparable with Westergren method and expressed in millimeters per hour (mm/h).

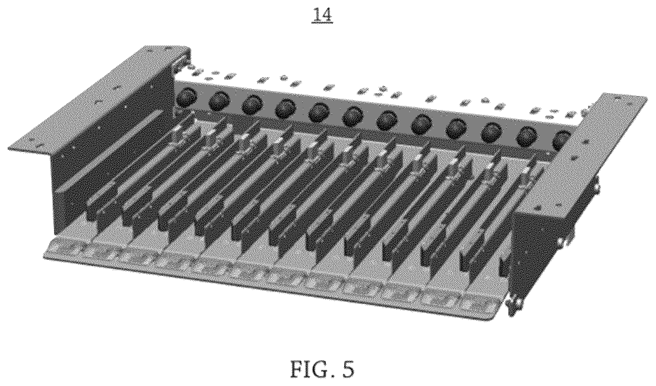

In FIG. 5, the rack holding system 14 is illustrated. As described above, the rack holding system 14 can hold any number of homogeneous racks.

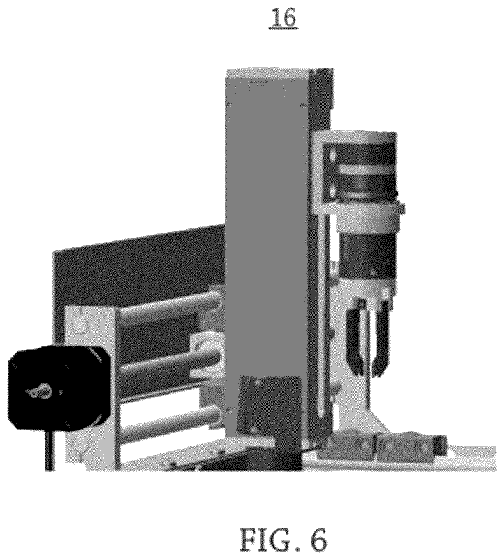

In FIG. 6, the robotic arm 16 is illustrated. As described above, The robotic arm 16 picks up a sample tube from any rack position in the rack and loads it into the mixing wheel 18 of the analytical unit 12.

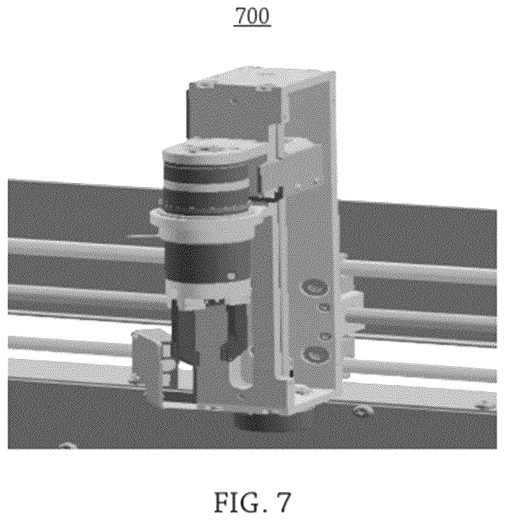

In FIG. 7, is another exemplary robotic arm 700 is illustrated.

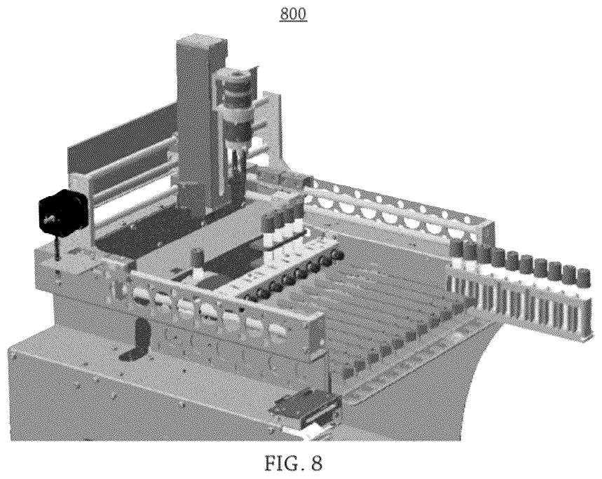

In FIG. 8, an exemplary loading rack 800 is illustrated.

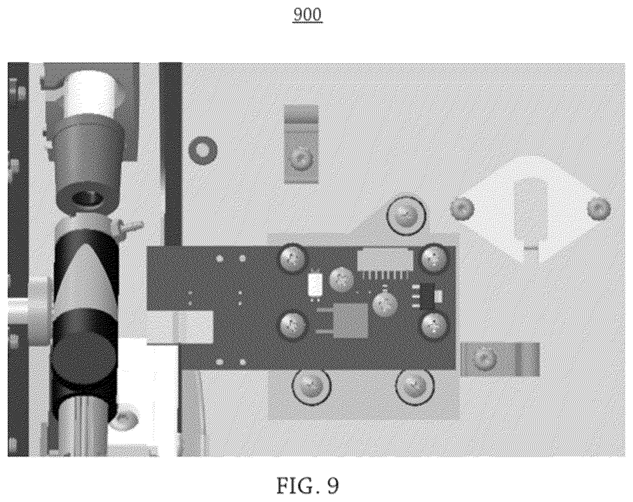

In FIG. 9, an exemplary piercing system reading cell 900 is illustrated.

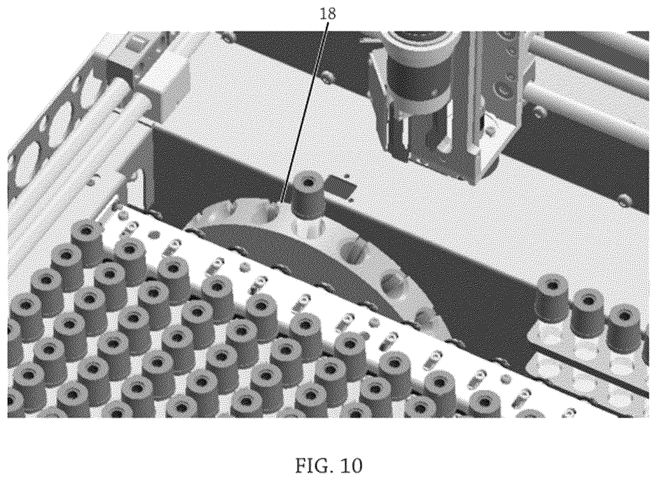

In FIG. 10 the mixing wheel 18 is illustrated.

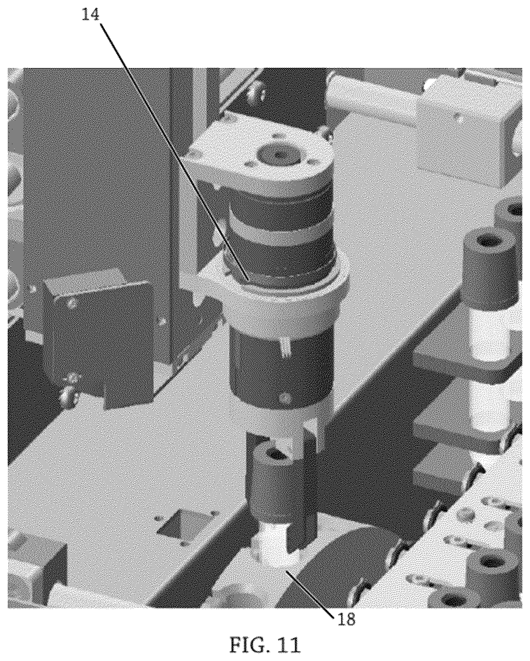

In FIG. 11, an exemplary arm 14/tube mixing wheel 18 interaction is illustrated.

In various embodiments, the present invention can be directed towards an apparatus, a method, and a system for the determination of the aggregation rate of red blood cells. More specifically, the present invention can be a method, a system, and the relative apparatus used to determine the aggregation rate of red blood cells, and other parameters related to these, such as acute phase proteins in the field of in vitro medical analyses, using optical systems after or during inducted forces for red blood cell disruption and redistribution generated by premixing, laminar and turbulent flow or in situ ultrasound waves.

In an embodiment, the present invention provides a method and a relative reusable apparatus for the determination of aggregation rate index, and subsequent acute phase proteins concentration for whole blood samples. The present invention can also be used to derive other rheological parameters such as red blood cell deformability, red blood cell elasticity and whole blood density.

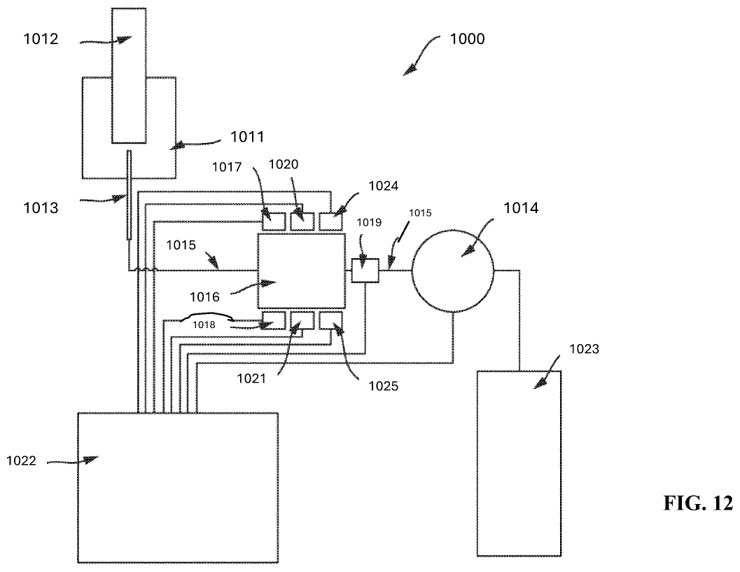

Referring to FIG. 12, in an embodiment, an exemplary apparatus 1000 for determination of red blood cell (RBC) aggregation, and their subsequent sedimentation rate, includes a reading cell container 1016 where a sample is introduced. The apparatus 1000 provides this reading cell container 1016 equipped with two parallel optical windows for allowing light radiation to pass through the sample therein introduced or reading the backscatter of the incident light. The apparatus 1000 includes a collimated light source 1017 composed in such way that light passes through the windows of the container 1016 mentioned above and can be reflected. On the opposite side of the light source 1017, there is an optical detector 1018 for the evaluation of the light attenuated by the sample. The optical detector 1018 can be positioned on the same side of the light source 1017 for the detection of light scattering. The reading cell container 1016 is equipped with electromechanical actuators 1020, 1021 able to vibrate the sample herein introduced, disrupting the RBC aggregates that naturally form in the blood sample when in stasis, and evenly distributing the erythrocytes within the entire volume of sample. The apparatus 1000 has a temperature control system 1024, 1025 for the sample container 1016 to standardize the reaction environment.

The apparatus 1000 includes an electronic control device 1022 able to acquire the optical variance detected by the optical detector 1018, drive the electromechanical actuators 1020,1021 and acquire the container temperature values. This electronic control device 1022 is also able to convert a detected time dependent light variation into an aggregation index and a subsequent erythrocyte sedimentation rate, providing a result of the evaluated phenomenon in the way of a numerical result comparable to the commonly used parameters used in a clinical laboratory.

In an embodiment, the apparatus 1000 includes a mixer device 1011 for a low homogenization of the sample inside a collection tube 1012. The homogenization can be achieved by a Vortex-like mixer or by the radial or axial rotation of the sample tube, or a combination of the two techniques. Vortex mixers are one of the primary technologies for mixing laboratory samples in test tubes, well plates, or flasks. Vortex mixers can use a fairly simple mechanism to agitate samples and encourage reactions or homogenization with high degrees of precision. Motorized drive shafts beneath a sample platform oscillate rapidly and transfer orbital motion to sample containers loaded into the vortex mixer. This causes sample fluids to circulate and undergo turbulent flow, otherwise known as a vortex.

After homogenization, the sample is then withdrawn by a needle 1013 and aspirated by a pump device 1014 through a hydraulic circuit 1015. The hydraulic circuit 1015 connects the aspiration needle 1013 to the reading cell container 1016 to enable their filling by the sample, guaranteed by the optical sensor composed by the emitter 1017 and an optical receiver 1018 and a secondary optical flow sensor 1019 controlled by an electronic control device 1022.

The light emitter source 1017 includes, in one embodiment, a light emitting diode (LED), and can be substituted, for example, by a laser source or an incandescent lamp. The optical receiver 1018, in this embodiment, may include a charge-coupled device (CCD) sensor for two-dimensional characterization of the reaction or linear photodiode array for a monodimensional characterization. This CCD sensor can be substituted with a single receiver element such as photodiode, photomultiplier, and so forth.

After a complete or desired filling of the reading cell 1016, the pump device 1014 is stopped by the electronic control device 1022, and the sample is processed by the electromechanical devices 1020, 1021, for example composed by piezoceramics, activated to a predetermined power by the control device 1022, to disrupt aggregates and evenly re-suspend the RBC on the sample volume. One prerequisite for an aggregation kinetic detection is a complete disruption of the RBC aggregates, normally formed when the sample is in stasis. This emulsification can be achieved by an intensive mixing phase before and during the transportation of the sample in the reading cell or detection.

As an alternative embodiment to a predetermined power, the piezoceramic power is initially ramped up to a level where red blood cell disruption is detected through the optical reading. This process is stopped and a duplicate sample is introduced. The power applied can be optimized at a fraction of the red blood cell disruption power level which results in maximum dispersion, without cell damage.

During this phase, the control device 1022 acquires the signal detected by the optical receiver 1018 and stops the electromechanical devices 1020, 1021 or actuators when the light variation detected by the receiver 1018 stops decreasing, indicating the complete disruption of the aggregate present into the sample. This recorded plot expresses the disruption rate of the RBC aggregates and is post-evaluated by the apparatus 1000.

In one embodiment, the shape of the reading cell container 1016 walls includes sound lenses for focusing a wave pressure shear to emphasize a shear inducted to the sample.

After the electromechanical devices 1020,1021 stop, the signal detected by the receiver 1018 is still recorded by the control device 1022 for a predetermined amount of time as a plot of kinetic aggregation.

After the end of the acquisition, the sample is evacuated from the reading cell 1016 by the pump device 1014 to a waste reservoir 1023. During the evacuation, the electromechanical devices 1020, 1021 are activated with a high power to remove proteins bonded to the walls of the reading cell container 1016. An evacuation of the reading chamber 1016 avoids the pollution of the sample currently under measure by a residual of the previous measured sample with washing and does not require a large flow amount of sample currently under measure for removal the residuals of the previous measured sample. After the evacuation, the apparatus 1000 is ready for a new sample and analysis.

The reading cell container 1016 is also maintained to a controlled temperature by the thermoelectric device 1024 and the temperature is acquired by the control device 1022 through the temperature sensor 1025 for providing standardized conditions of reaction.

During the dispersion phase induced by the electromechanical devices 1020, 1011, the resultant signal is evaluated to extract a mean viscosity value of the sample plasma by considering the time needed by the sample to completely re-suspend. After a complete re-suspension of the sample, a burst of ultrasound waves is induced to the sample for evaluating the red blood cell deformability. This deformability is considered as a time needed by the media to absorb a wave shear impressed, also decay after the wave share absorption is evaluated in function of time as index of the mean shape recovery ability.

### High-Throughput ESR Analyzer

### Definitions

As used herein, the following terms have the meanings ascribed to them unless specified otherwise.
“Erythrocyte Sedimentation Rate” or “ESR” refers to the rate at which red blood cells (erythrocytes) in anticoagulated whole blood descend in a standardized tube over a period of one hour. It is a common, non-specific hematology test that may indicate inflammation.
“ESR Analyzer” refers to an automated or semi-automated instrument designed to perform ESR testing on blood samples. As used herein, it refers to a system comprising the components and configured to perform the methods as described.
“Scanner Module” (or Scanner) refers to a component or sub-system of the analyzer configured to automatically identify and read machine-readable labels, such as barcodes, on blood sample collection tubes. The scanner module is further configured to process the information from the barcode to determine if a sample requires ESR analysis and to signal a control system to direct the sample's workflow path accordingly.
“Rack” refers to a carrier or holder designed to contain and transport a plurality of blood sample collection tubes in an organized manner, typically in an array of rows and columns, for processing by an automated analyzer.
“Collection Tube” refers to a vessel, such as a standard evacuated blood collection tube (e.g., a Vacutainer®), used to hold a patient's blood sample. Such tubes are typically sealed with a pierceable septum or cap and bear an identifying label, such as a barcode.
“Barcode” refers to a machine-readable representation of data, typically in the form of parallel lines of varying widths and spacings or a 2D matrix, affixed to a collection tube. The barcode encodes information such as a patient identifier, a sample accession number, and/or a list of ordered tests.
“Mixer Device” refers to a mechanism within the analyzer responsible for agitating the blood samples to ensure a homogenous suspension of erythrocytes prior to analysis. As disclosed herein, the mixer device is specifically configured to hold multiple collection tubes and move them through different operational positions. An exemplary embodiment is a “mixing wheel.”
“Hydraulic Circuit” or “Hydraulic Transport Circuit” refers to the system of tubing, pumps, valves, and connectors that transports a fluid, such as a portion of a blood sample or a system reagent, from one point in the analyzer to another, for example, from a point of aspiration to a point of analysis or disposal.
“Pump” refers to a device that moves fluids (liquids or gases) by mechanical action. For example, in the context of the present invention, it can be used to create positive or negative pressure to aspirate a blood sample portion from a collection tube and transport it to the reading cell.
“Reading Cell” or “Reading Cell Container” refers to a component, typically having optically transparent walls, within the ESR analyzer where the portion of the blood sample is held stationary for optical measurement. It can be fluidly connected to the hydraulic circuit.
“Light Emitter Source” refers to a component, such as a light-emitting diode (LED) or laser diode, positioned to direct a beam of light of a specific wavelength through the blood sample portion contained within the reading cell.
“Optical Receiver” refers to a light-sensitive detector, such as a photodiode or phototransistor, positioned to detect light that has passed through or been scattered by the blood sample portion in the reading cell. The optical receiver generates an electrical signal (an “ESR-related signal”) corresponding to the intensity of the detected light.
“Robotic Arm” refers to an automated mechanical manipulator used within the analyzer to perform physical tasks, such as gripping, lifting, moving, and placing objects. For example, it can be configured to load and unload selected blood sample collection tubes between racks and the mixer device.
“Needle” refers to a hollow cannula, typically made of metal, designed for piercing a septum or cap of a collection tube and for aspirating (withdrawing) or dispensing a fluid sample.
“Mixing Wheel” refers to a specific embodiment of a mixer device, comprising a rotatable carousel or wheel with a plurality of holders for receiving and securing collection tubes. The rotation of the wheel serves to both mix the samples (e.g., by inversion) and to present the tubes sequentially to different operational positions.
“Operational Positions” refers to distinct, spatially separated locations on or around the mixer device where specific operations are performed. For example, a “first position” may be designated for loading and unloading of tubes by a robotic arm, while a “second position” can be designated for piercing and sample aspiration.
“Piercing Position” refers to a specific operational position where a collection tube's septum is pierced by a needle for the aspiration of a portion of the blood sample.
“ESR-related signal” refers to the raw or processed data generated by the optical receiver, which typically reflects a change in light transmission or scattering over time as erythrocytes aggregate and sediment. This signal is used by the analyzer's control system to calculate the final ESR value.
“Electronic Control System” refers to the one or more processors, microcontrollers, or computer systems, including associated memory and software or firmware that are programmed to coordinate and control the operations of the various components of the ESR analyzer, including the scanner module, robotic arm, mixer device, hydraulic circuit, and optical detection assembly, to execute the analysis workflow.

### High-Throughput ESR Analyzer System & Method Overview

In another embodiment, the present invention provides an automated ESR analyzer configured for high-throughput operation, improved efficiency, and reliability in a laboratory environment.

Generally, the ESR analyzer and methods are centered on an intelligent, barcode-driven, selective processing workflow. A feature of the disclosed system is the integration of a blood sample identification step at the front-end of the analyzer with a physical sample handling system that ensures only those blood samples explicitly requiring ESR analysis are subjected to the mechanical steps of mixing, piercing, and aspiration. All other blood samples are intelligently bypassed, streamlining the entire analytical process.

The ESR analyzer can comprise a scanner module, a robotic arm, a mixer device, a piercing and aspiration station, a hydraulic transport circuit, and an optical detection assembly, all operating under the control of an electronic control system. The process begins when a rack of blood sample collection tubes is introduced to the scanner module. The scanner reads a barcode on each tube to identify the sample and determine, for example from a laboratory information system (LIS), whether an ESR test has been ordered.

Based on this barcode-derived information, the electronic control system directs the workflow. If the system determines that no tubes in a given rack require ESR analysis, the entire rack is moved to an exit path, completely bypassing the processing modules. If a rack contains a mix of samples, the system directs the robotic arm to selectively pick only those specific tubes for which an ESR test is ordered and load them into the mixer device. The tubes not requiring ESR analysis remain in the rack and are excluded from all subsequent handling, mixing, and piercing steps.

This selective loading provides an advantage, as it directly reduces the mechanical stress and wear on the piercing needle and mixer components, extending their operational life and reducing maintenance requirements. Furthermore, by eliminating the time spent handling and processing unnecessary samples, the overall sample-to-sample cycle time is reduced, increasing the throughput of the analyzer.

Once a selected tube is loaded onto the mixer device (e.g., a rotatable mixing wheel), it is thoroughly mixed to ensure the blood sample is a homogenous suspension. The tube is then presented to a piercing station where a needle pierces the tube's cap. A precise portion of the mixed blood is then withdrawn through the needle by a pump and transported via a hydraulic circuit to a reading cell. The coordination of mixing and piercing ensures that the sample is withdrawn while still in a fully mixed state, which is for preventing erythrocyte reaggregation that can introduce measurement errors. Inside the reading cell, an optical assembly measures the rate of red blood cell aggregation over time to determine the ESR value. The entire sequence—from barcode scanning and robotic selection to optical measurement—is automated and coordinated by the electronic control system to provide a highly efficient, reliable, and cost-effective solution for ESR analysis.

Having described the general principles and definitions of the disclosure, specific, non-limiting embodiments will now be described in greater detail with reference to the figures.

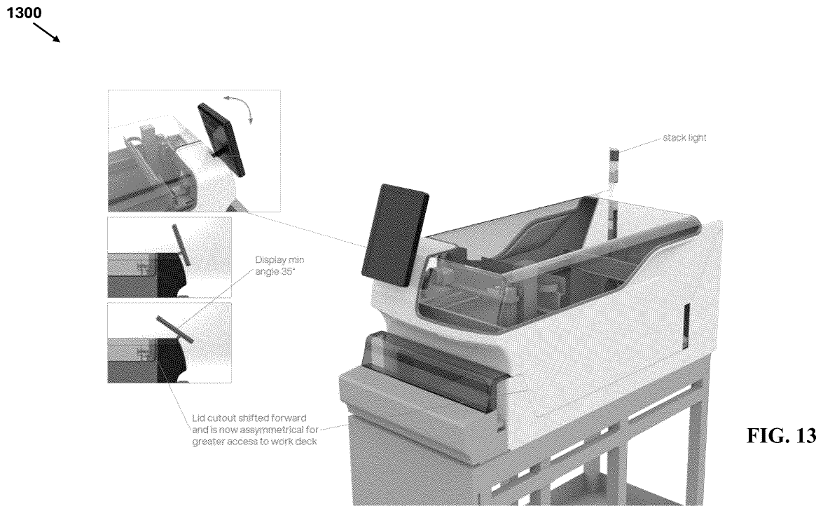

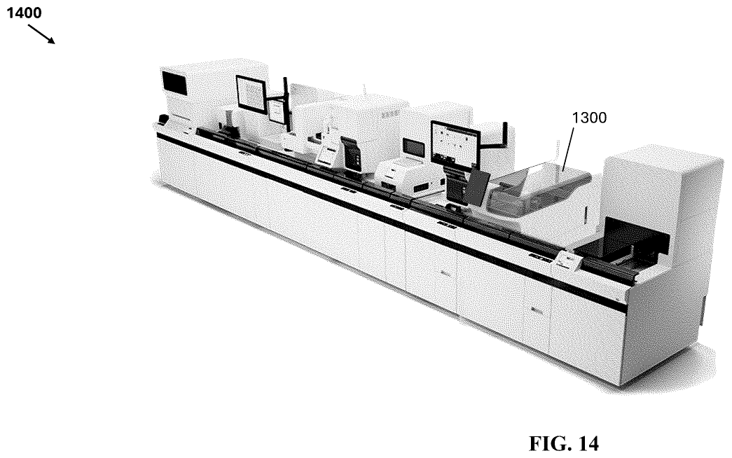

Referring to FIG. 13 and FIG. 14, in an embodiment, the present invention provides an ESR analyzer 1300 that can be configured for high-throughput operation. The ESR analyzer 1300 can be operated as a standalone diagnostic instrument as shown in FIG. 13, or as shown in FIG. 14, the ESR analyzer 1300 can be integrated with other diagnostic instruments and equipment in a laboratory environment 1400.

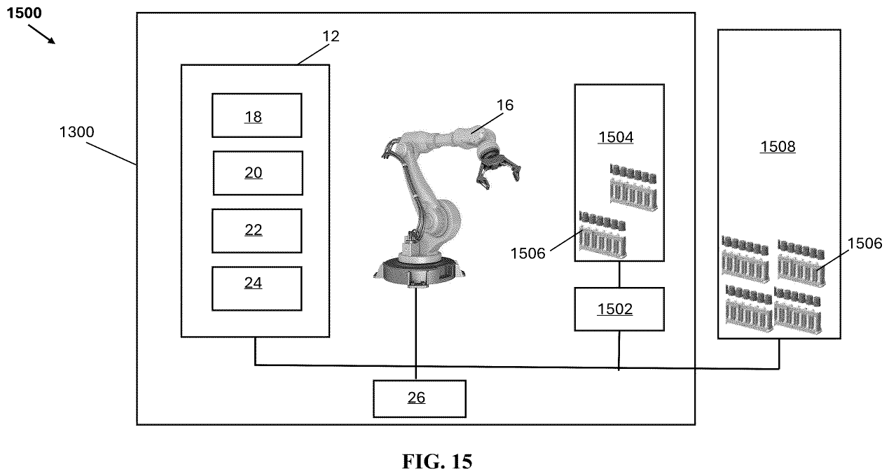

Referring to FIG. 15, block diagram 1500 illustrates internal components and external interfaces of the ESR analyzer 1300 that include improvements over the ESR analyzer 10 discussed above in connection with FIG. 1. In an embodiment, the ESR analyzer 1300 can include an internal buffer (i.e., queueing area) or rack holding mechanism 1504 to hold multiple racks 1506 of blood samples. Each blood sample is contained in a corresponding collection tube, and a barcode can be associated with each collection tube. An external rack holding mechanism 1508 (e.g., Sysmex XN) can also be coupled to the ESR analyzer 1300 and used to increase overall throughput capacity by holding additional racks 1506 of blood sample collection tubes.

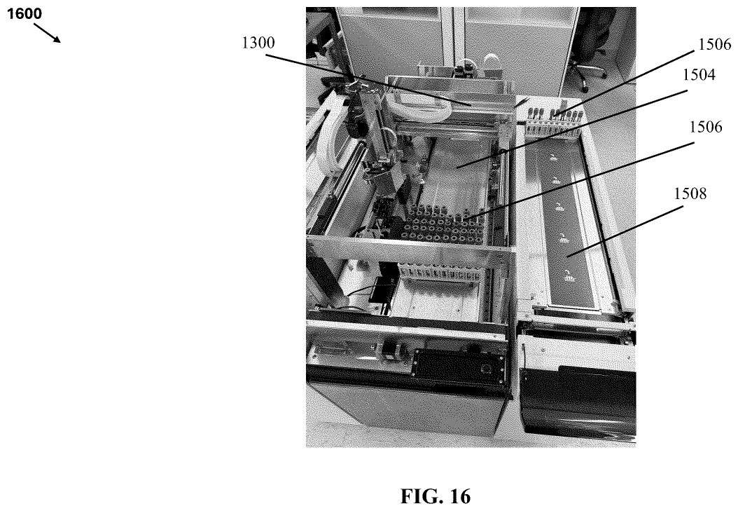

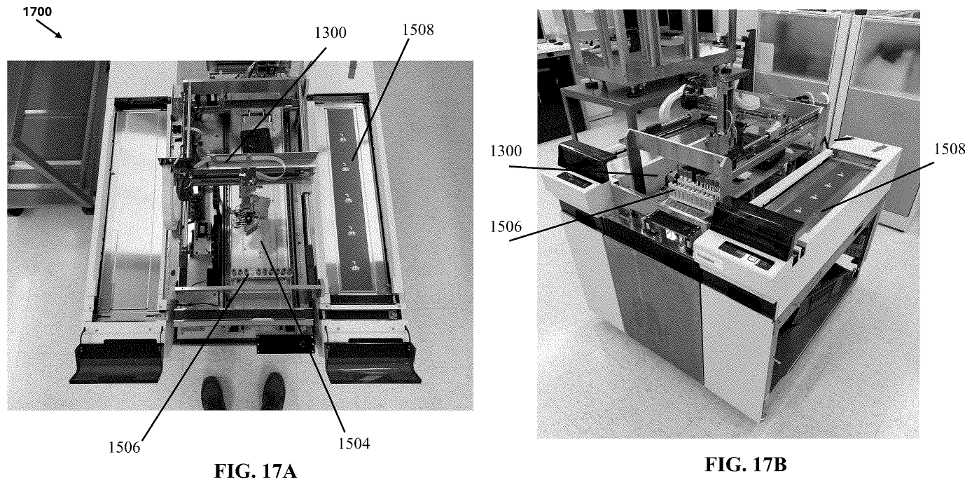

Referring also to FIG. 16, FIG. 17A and FIG. 17B, images of the ESR analyzer 1300 and external rack holding mechanism 1508 are depicted. In an embodiment, the internal rack holding mechanism 1504 can queue up and hold 24 racks 1506 with each rack 1506 having 10 blood sample collection tubes. This capacity can be extended further by utilizing the external rack holding mechanism 1508, which in an embodiment, can hold 28 additional racks 1506 of blood samples providing a total increased throughput and buffer capacity of 52 racks having 520 blood sample collection tubes. In other embodiments, capacity can further be increased by utilizing larger external rack holding mechanisms.

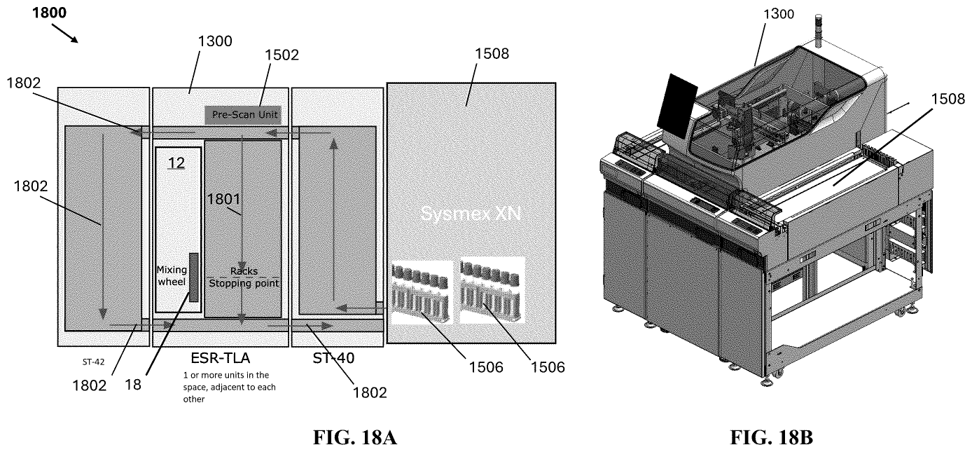

Referring to FIG. 15, FIG. 18A and FIG. 18B, the ESR analyzer 1300 can include a scanner module 1502 that enhances the selectivity and efficiency of the ESR analyzer 1300. The scanner module 1502 can receive one or more racks 1506 of blood samples from the rack holding mechanisms 1504, 1508. Upon receipt of a rack 1506, the scanner module 1502 can first orient the blood sample collection tubes by spinning them to ensure barcodes are readable. This orientation step avoids issues arising where misaligned tubes lead to scanning failures.

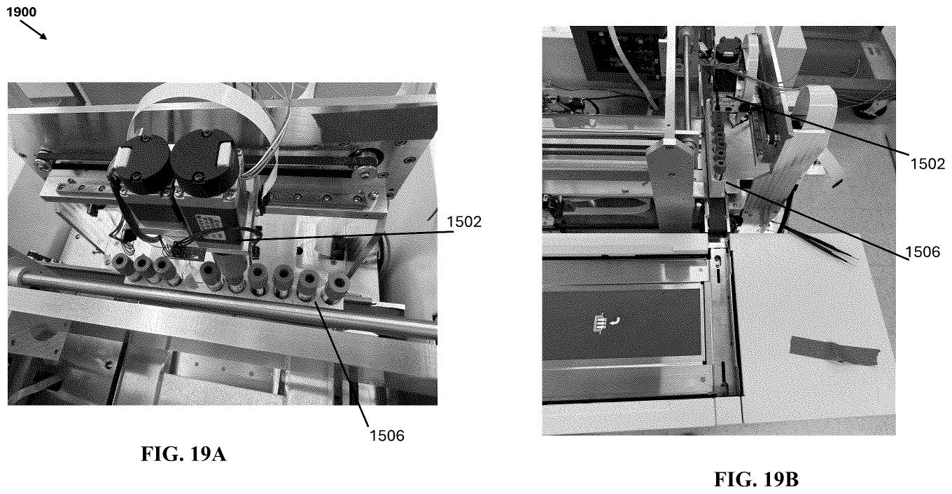

Once oriented, the scanner module 1502 can scan the barcode on each blood sample collection tube (e.g., 10 tubes per rack) in the associated rack 1506. The scanner module 1502 can then query an external Laboratory Integration System (LIS) using the barcode to obtain information such as test orders, patient identifiers, sample identifiers, tube types, priority status, expiration date, and other details. Based on this data, the scanner module 1502 determines which blood sample collection tubes require ESR analysis. FIG. 19A and FIG. 19B show images of the scanner module 1502 scanning barcodes on each blood sample collection tube in a rack 1506.

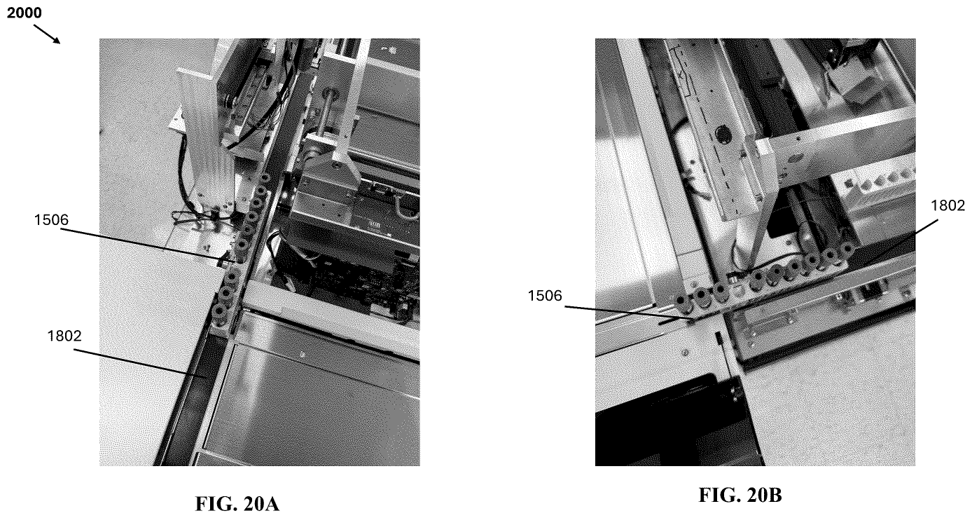

Racks containing blood sample collection tubes requiring ESR analysis can then be pushed into the analytical unit 12 along trajectory 1801 (see FIG. 18A) and loaded into the mixing wheel 18 by the robotic arm 16 for further processing. Blood sample collection tubes not requiring ESR analysis are not loaded into the mixing wheel 18 and remain in their rack 1506 and are ignored during subsequent steps, preventing unnecessary processing. If a rack 1506 contains at least one blood sample collection tube requiring analysis, only those collection tubes proceed to the mixing and analysis phases for further processing, while others are bypassed within the rack 1506. If an entire rack 1506 has no blood sample collection tubes requiring ESR analysis, the entire rack 1506 can be diverted along trajectory 1802 (see FIG. 18A) to a bypass area, avoiding bottlenecks and congestion in the analytical unit 12. This bypass function is further illustrated in FIG. 20 A and FIG. 20B. As shown in FIG. 20A, depicted is an image of a rack 1506 of blood collection tubes propagating along bypass trajectory 1802 as it leaves the scanner module 1502 with no collection tubes requiring ESR analysis, and FIG. 20B shows the rack 1506 propagating along the bypass trajectory 1802 as the rack 1506 passes the opposite end of the analytical unit 12.

This selective processing reduces unnecessary handling, shortens cycle times, and avoids bottlenecks within the ESR analyzer 1300. In some embodiments, the scanner module 1502 can prevent loading improperly identified or expired blood sample collection tubes, further ensuring quality control. Priority status from barcodes can also be used to sequence blood samples during further processing by the ESR analyzer 1300.

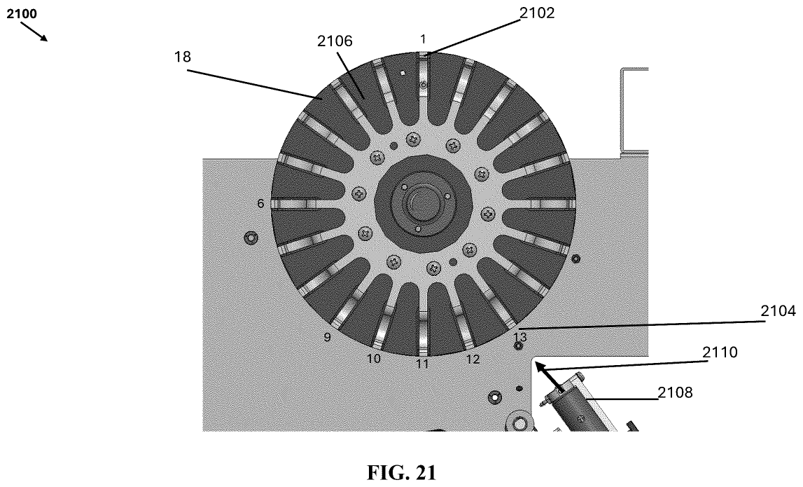

Referring also to FIG. 21, in an embodiment, the ESR analyzer 1300 can include a mixer device, such as a rotating mixing wheel 18, configured to mix the blood samples within their respective collection tubes that are identified by the scanner module 1502 as needing ESR analysis. The mixing wheel 18 can be a rotatable platform or similar mechanism that gently inverts the blood sample collection tubes multiple times or for a predetermined duration to achieve homogeneous mixing, preventing premature sedimentation that could skew ESR analysis results.

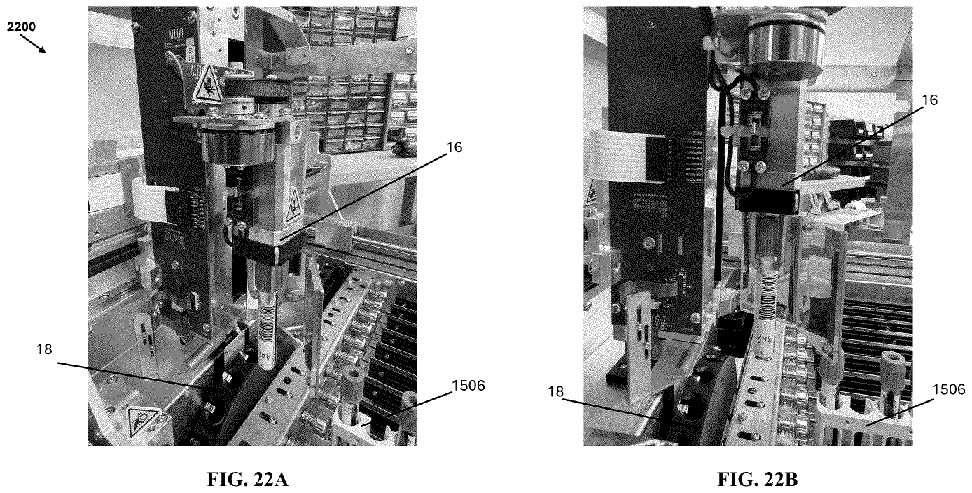

Referring also to FIG. 22A and FIG. 22B, in an embodiment, the mixing wheel 18 in coordination with the robotic arm 16 can be configured for simultaneous automated loading and unloading of blood sample collection tubes at a first position 2102 on the mixing wheel 18 using the robotic arm 16. Automated piercing of the collection tubes can occur at a second position 2104 on the mixing wheel 18 using a piercing mechanism 2108. Loading/unloading and piercing can thus occur concurrently at different positions on the mixing wheel. This parallelism allows continuous workflow; for example, while one blood sample collection tube is being pierced for blood sample withdrawal, another can be loaded into or unloaded from the mixing wheel 18 at the same time.

The robotic arm 16 can include a barcode reader of its own that can be used to read the barcode on the blood sample collection tubes in an associated rack 1506 to select and pick up the collection tubes that the scanner module 1502 identified as needing ESR analysis. The robotic arm 16 can then load and unload the blood sample collection tubes into the tube holders 2106 of the mixing wheel 18.

The mixing wheel 18 can operate in continuous rotation or indexed steps, with discrete positions for loading/unloading and piercing. Tube holders 2106 on the mixing wheel 18 maintain blood sample collection tubes in a substantially vertical orientation during loading and unloading operations at the first position 2102. Mixing can occur for a predetermined duration followed immediately by piercing of the blood sample collection tubes at the second position 2104 to minimize reaggregation phenomena that can induce measurement errors. In an embodiment, piercing of the blood sample collection tubes can be performed at a fixed angular position of the mixing wheel 18 relative to the piercing mechanism 2108, and the loading, mixing, and piercing operations can occur without removing the blood sample collection tube from the mixing wheel 18.

This integrated design reduces dwell times, coordinates mixing and piercing to maintain sample mixed state during withdrawal and decreases overall processing time. By avoiding handling of non-required samples, the system further extends the lifespan of piercing components and enhances throughput.

In an embodiment, the piercing mechanism 2108 can include a needle 2110 configured for insertion into a blood sample collection tube to withdraw a portion of the thoroughly mixed blood sample. The needle 2110 can be connected to the hydraulic circuit 24, which uses a pump to transport the blood sample portion to a reading cell container 22. The reading cell 22 can be operationally connected to the hydraulic circuit 24 and positioned between a light emitter source and an optical receiver. Light from the emitter source passes through the blood sample portion within the reading cell, and the optical receiver detects the resulting scattered light to generate an ESR-related signal that varies as a function of red blood cell aggregation behavior. The ESR value can be determined from this signal, typically based on the rate of red blood cell aggregation derived from time-dependent changes in the optical data. Measurements can be performed while the blood sample is stationary in the reading cell 22 for accuracy.

The electronic control system 26 coordinates barcode scanning, robotic arm operation, mixing wheel rotation, piercing, withdrawal, transport, and optical measurement. By selectively processing only those blood samples requiring ESR analysis, the system reduces mechanical stress on piercing components, shortens sample-to-sample cycle time, and improves overall analyzer efficiency and reliability.

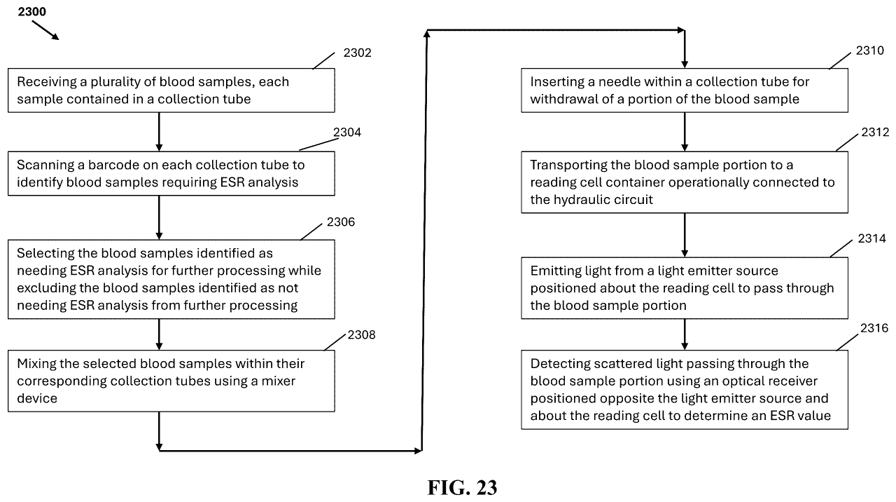

Referring to FIG. 23, in an embodiment, the present invention provides a method 2300 for determining an ESR of blood samples by providing and using an ESR analyzer as described herein. The method 2300 can include receiving (2302) multiple blood samples that are each contained in corresponding collection tubes, and scanning (2304) a barcode on each collection tube to identify the blood samples requiring ESR analysis. The method 2300 can further include selecting (2306) the blood samples identified as needing ESR analysis for further processing while excluding the blood samples that do not require ESR analysis.

The method 2300 can include mixing (2308) the selected blood samples in their respective collection tubes using a mixer device, such as mixing wheel 18. The step of mixing (2308) can include utilizing the robotic arm 16 for automated loading and unloading of the selected blood sample collection tubes into and from the mixing wheel 18. As discussed above, in an embodiment, the mixing wheel 18 can be configured for automated loading and unloading of the blood sample collection tubes at a first position on the mixing wheel 18, and automated piercing of the blood sample collection tubes at a second position on the mixing wheel 18. In an embodiment, the automated loading, unloading, and piercing steps can occur simultaneously.

The method 2300 can also include the steps of inserting (2310) a needle into a selected collection tube to withdraw a portion of the blood sample in the collection tube and transporting (2312) the withdrawn blood sample portion to a reading cell container. As discussed above, in an embodiment, the needle can be connected to a hydraulic circuit for transporting the blood sample portion using a pump and the reading cell can be operationally connected to the hydraulic circuit. The method 2300 can include emitting light to pass through the withdrawn blood sample portion in the reading cell.

In an embodiment, the emitted light can be obtained from a light emitter source positioned about the reading cell. The method 2300 can also include detecting (2316) scattered light passing through the blood sample portion in the reading cell to determine an ESR value. The step of detecting (2316) can include utilizing an optical receiver positioned opposite the light emitter source and about the reading cell to determine the ESR value.

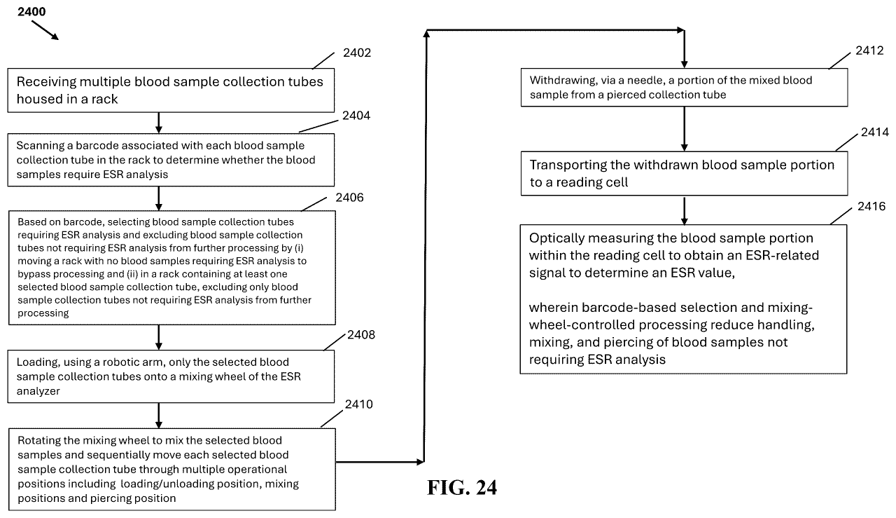

Referring to FIG. 24, in an embodiment, the present invention provides a method 2400 for processing blood samples using an automated ESR analyzer to determine an ESR value. In an embodiment, the automated ESR analyzer 1300 can include a scanner module 1502, mixing wheel 18, robotic arm 16, piercing mechanism 2108, hydraulic transport circuit 24, reading cell 22, an optical detection assembly within the reading cell 22, and an Electronic Control System 26.

In an embodiment, the method 2400 can include receiving (2402) at least one rack containing multiple blood sample collection tubes into a sample handling region of the ESR analyzer, and scanning (2404) a barcode on each blood sample collection tube in the rack to determine which, if any, of the blood samples require ESR analysis. The step of scanning (2404) can include utilizing a barcode reader on the scanner module to obtain information pertaining to the blood samples in each collection tube. Based on the information derived from scanning (2404), the method 2400 can include automatically selecting (2406) blood samples identified as requiring ESR analysis for further processing and excluding the blood samples that do not require ESR analysis.

In an embodiment, the step of “excluding from further processing” can include moving a rack not having any selected blood sample collection tubes requiring ESR analysis to entirely bypass further processing in the ESR analyzer. In the event a rack contains at least one selected blood sample requiring ESR analysis, the step of excluding pertains only to those blood samples in the rack that do not require ESR analysis.

The method 2400 can include loading (2408) the selected blood sample collection tubes into a mixer device, such as a rotatable mixing wheel, in the ESR analyzer. The step of loading (2408) can further include utilizing the robotic arm to automatically load and unload the selected blood sample collection tubes into the mixing wheel or other mixer device. The method 2400 can include rotating (2410) the mixing wheel to thoroughly mix the selected blood samples and to sequentially move each selected blood sample collection tube through multiple operational positions including at least: (i) a loading and unloading position at which the collection tube is inserted or removed from the mixing wheel by the robotic arm, (ii) multiple mixing positions at which the blood sample is mixed within the collection tube by rotational motion of the mixing wheel, and (iii) a piercing position at which the collection tube is pierced while the blood sample remains in a mixed state.

In an embodiment, rotating (2410) includes mixing the selected blood samples for a predetermined duration prior to piercing, and the actions of mixing and piercing can be performed without removing the blood sample collection tube from the mixing wheel. In an embodiment, the automated loading, unloading, and piercing functions can occur simultaneously.

The method 2400 can also include the steps of withdrawing (2412) a portion of the mixed blood sample from the pierced collection tube and transporting (2414) the withdrawn blood sample portion through the hydraulic transport circuit to the reading cell. In an embodiment, withdrawing (2412) includes utilizing a needle and a pump that is fluidly connected to the hydraulic transport circuit to extract the portion of the mixed blood sample from the collection tube. The method 2400 can further include optically measuring (2416) the blood sample portion within the reading cell to obtain an ESR-related signal for determining an ESR value.

In various embodiments, the step of optically measuring (2416) can further include emitting light to pass through the withdrawn blood sample portion in the reading cell. The emitted light can be obtained from a light source positioned about the reading cell. The step of optically measuring (2416) can also include detecting scattered light passing through the blood sample portion in the reading cell to determine an ESR value. Detecting the scattered light can include utilizing an optical receiver positioned opposite the light source and about the reading cell to determine the ESR value.

In other embodiments, the step of scanning (2404) a barcode can include the steps of identifying one or more of a test order, patient identifier, sample identifier, tube type, or priority status pertaining to a blood sample; and prioritizing selected blood sample collection tubes on the mixing wheel based on such barcode-derived information. Additional steps that can be included in method 2400 include: (i) preventing loading of improperly identified or expired blood sample collection tubes into the mixing wheel based on barcode-derived information; (ii) continuously rotating the mixing wheel when loaded with blood samples to thoroughly mix the blood samples; (iii) stopping rotation of the mixing wheel to perform piercing operations on the selected blood samples; (iv) operating the mixing wheel in indexed rotational steps corresponding to discrete operational positions; (v) mixing the blood samples in the mixing wheel for a predetermined duration prior to piercing; (vi) piercing blood sample collection tubes at a fixed angular position of the mixing wheel relative to the needle; (vii) maintaining the blood sample collection tubes in a substantially vertical orientation during insertion of the blood sample collection tubes into the mixing wheel; (viii) coordinating mixing and piercing of the blood sample collection tubes such that piercing occurs immediately after mixing without intermediate dwell time; (ix) withdrawing the blood sample portion while it is in a mixed state to reduce reaggregation phenomena that can induce measurement errors; (x) mixing and piercing blood sample collection tubes without removing them from the mixing wheel; (xi) determining the ESR value using the red blood cell rate of aggregation; (xii) deriving the red blood cell aggregation rate from a time-dependent change in the optically detected signal; (xiii) performing the optical measurement step while the blood sample portion is stationary inside the reading cell; (xiv) reducing mechanical stress on piercing components by excluding blood sample collection tubes not requiring ESR analysis; (xv) selectively processing blood samples to reduce overall sample-to-sample cycle time; and (xvi) utilizing an electronic control system or processor to coordinate control of the barcode scanning, robotic arm, mixing wheel rotation, piercing, withdrawal, fluid transport, and optical detection and measurement steps, thereby reducing handling of unnecessary samples, decreasing cycle time, and improving analyzer throughput and reliability.

The methods (2300, 2400) disclosed herein are designed to reduce handling and processing of blood samples not requiring ESR analysis, thereby improving throughput, efficiency, and accuracy of the ESR analyzer. The barcode-based selection and mixing-wheel-controlled processing can reduce handling, mixing, and piercing of blood samples not requiring ESR analysis.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. An erythrocyte sedimentation rate (ESR) analyzer comprising:
a scanner module configured to: (a) receive a plurality of blood samples housed in a rack, each blood sample contained in a corresponding collection tube, (b) scan a barcode on each blood sample collection tube in the rack to identify blood samples requiring ESR analysis, (c) pass the blood samples identified as needing ESR analysis for processing while excluding the blood samples identified as not needing ESR analysis from further processing, wherein excluding from further processing includes (i) moving a rack not having any blood sample collection tubes requiring ESR analysis to entirely bypass further processing, and (ii) in a rack containing at least one blood sample collection tube requiring ESR analysis, excluding only blood sample collection tubes not requiring ESR analysis from further processing;
a mixer device configured for mixing the blood samples within their corresponding collection tubes, the mixer device further configured for simultaneous automated loading and unloading of the blood sample collection tubes at a first position on the mixer device, and automated piercing of the blood sample collection tubes at a second position on the mixer device;
a needle configured for insertion within the collection tube for withdrawal of a portion of the blood sample, the needle connected to a hydraulic circuit for transporting the blood sample portion using a pump;
a reading cell container operationally connected to the hydraulic circuit configured for receipt of the blood sample portion;
a light emitter source positioned about the reading cell to pass light through the blood sample portion; and
an optical receiver positioned opposite the light emitter source and about the reading cell to detect scattered light passing through the blood sample portion to obtain an ESR-related signal to determine an ESR value.

2. The ESR analyzer of claim 1 further comprising a robotic arm configured to load and unload blood samples requiring ESR analysis into the mixer device.

3. A method for determining an erythrocyte sedimentation rate (ESR) of blood samples, the method comprising:
providing the ESR analyzer of claim 1;
receiving a plurality of blood samples, each blood sample contained in a corresponding collection tube;
scanning a barcode on each blood sample collection tube to identify blood samples requiring ESR analysis;
selecting the blood samples identified as needing ESR analysis for further processing while excluding the blood samples identified as not needing ESR analysis from further processing;
mixing the selected blood samples within their corresponding collection tubes using a mixer device, wherein the mixer device is configured for simultaneous automated loading and unloading of the blood sample collection tubes at a first position on the mixer device, via a robotic arm, and automated piercing of the blood sample collection tubes at a second position on the mixer device;
inserting a needle within one of the collection tubes for withdrawal of a portion of the blood sample, wherein the needle is connected to a hydraulic circuit for transporting the blood sample portion using a pump;
transporting the blood sample portion to a reading cell container operationally connected to the hydraulic circuit;
emitting light from a light emitter source positioned about the reading cell to pass through the blood sample portion; and
detecting scattered light passing through the blood sample portion using an optical receiver positioned opposite the light emitter source and about the reading cell to determine an ESR value.

4. A method for processing blood samples for erythrocyte sedimentation rate (ESR) determination using an automated ESR analyzer having a scanner module, mixer device, robotic arm, piercing mechanism, hydraulic transport circuit, reading cell, and an optical detection assembly, the method comprising:
receiving a plurality of blood sample collection tubes housed in a rack into a sample handling region of the ESR analyzer;
scanning, using a barcode reader on the scanner module, a barcode associated with each blood sample collection tube in the rack to determine whether the blood sample contained therein requires ESR analysis;
based on barcode-derived information, automatically selecting blood sample collection tubes requiring ESR analysis and excluding blood sample collection tubes not requiring ESR analysis from further processing, wherein excluding from further processing includes (i) moving a rack not having any selected blood sample collection tubes requiring ESR analysis to entirely bypass further processing, and (ii) in a rack containing at least one selected blood sample collection tube, excluding only blood sample collection tubes not requiring ESR analysis from further processing;
loading, using the robotic arm, only the selected blood sample collection tubes onto a rotatable mixing wheel of the ESR analyzer;
rotating the mixing wheel to thoroughly mix the selected blood samples and sequentially move each selected blood sample collection tube through a plurality of operational positions including at least:
a loading and unloading position at which the collection tube is inserted or removed from the mixing wheel by the robotic arm,
mixing positions at which the blood sample is mixed within the collection tube by rotational motion of the mixing wheel, and
a piercing position at which the collection tube is pierced while the blood sample remains in a mixed state;
withdrawing, via a needle and pump fluidly connected to the hydraulic transport circuit, a portion of the mixed blood sample from the pierced collection tube;
transporting the withdrawn blood sample portion through the hydraulic transport circuit to the reading cell; and
optically measuring the blood sample portion within the reading cell to obtain an ESR-related signal to determine an ESR value,
wherein barcode-based selection and mixing-wheel-controlled processing reduce handling, mixing, and piercing of blood samples not requiring ESR analysis.

5. The method of claim 4, wherein scanning the barcode comprises querying a LIS using the barcode to obtain at least one of a test order, patient identifier, sample identifier, tube type, priority status, and expiration date.

6. The method of claim 4, wherein barcode-derived information is used to prioritize selected blood sample collection tubes on the mixing wheel.

7. The method of claim 4, wherein the barcode reader prevents loading of improperly identified or expired blood sample collection tubes.

8. The method of claim 4, wherein the mixing wheel is configured to permit simultaneous automated loading and unloading of collection tubes at a first position and automated piercing of collection tubes at a second position.

9. The method of claim 4, wherein the mixing wheel operates in indexed rotational steps corresponding to discrete operational positions.

10. The method of claim 4, wherein mixing is performed for a predetermined duration prior to piercing.

11. The method of claim 4, wherein piercing occurs at a fixed angular position of the mixing wheel relative to the needle.

12. The method of claim 4, wherein the mixing wheel comprises a plurality of tube holders configured to maintain the blood sample collection tubes in a substantially vertical orientation during insertion of the blood sample collection tubes into the mixing wheel.

13. The method of claim 4, wherein loading and unloading, and piercing are coordinated such that piercing occurs immediately after mixing without intermediate dwell time.

14. The method of claim 4, wherein the blood sample remains in a mixed state during withdrawal to reduce reaggregation phenomena that can induce measurement errors.

15. The method of claim 4, wherein mixing and piercing are performed without removing the blood sample collection tube from the mixing wheel.

16. The method of claim 4, wherein the ESR value is determined using the red blood cell rate of aggregation.

17. The method of claim 4, wherein the red blood cell aggregation rate is derived from a time-dependent change in the optically detected signal.

18. The method of claim 4, wherein the optical measurement step is performed while the blood sample portion is stationary inside the reading cell.

19. The method of claim 4, wherein excluding blood sample collection tubes not requiring ESR analysis reduces mechanical stress on piercing components.

20. The method of claim 4, wherein selective processing reduces overall sample-to-sample cycle time.

21. The method of claim 4, wherein the barcode scanning, robotic arm, mixing wheel rotation, piercing, withdrawal, and optical measurement steps are coordinated by an electronic control system.
